(19) United States
(12) Patent Application Publication
(10) Pub. No.: US 2026/0152988 A1
(43) Pub. Date: Jun. 4, 2026

(54) UNIVERSAL THRESHOLD FOR ENTRYWAYS

(71) Applicant: Hawkes Design and Consulting, LLC, Charleston, SC (US)

(72) Inventor: Henry M. Hay, III, Charleston, SC (US)

(21) Appl. No.: 18/967,013

(22) Filed: Dec. 3, 2024

(51) Int. Cl. E06B 1/70; E06B 7/23

(52) U.S. Cl. CPC E06B 1/70; E06B 7/2316

(57) ABSTRACT

A universal threshold may include a base threshold portion. The base threshold portion includes a base attachment receiving mechanism at a first end and a slope portion at a second end. The base threshold portion also includes at least one weep hole defined along a longitudinal length of the base threshold portion. The universal threshold also includes a bumper adapter coupled to the base threshold portion. The bumper adapter is positioned to restrict movement of a door during usage. The universal threshold further include at least one seal coupled to the base threshold portion for sealing the door during usage.

### TECHNOLOGICAL FIELD

This disclosure relates generally to a universal threshold for entryways, and in particular to a universal threshold for doors with weep holes provided.

### BACKGROUND

Entryways and doors have different configurations based on various different factors. As such, door thresholds may not be appropriate for every door configuration. Door thresholds are typically extruded and therefore each different threshold has to be independently extruded, creating difficulty and cost to manufacturers. Therefore, there exists a need to allow for a universal threshold that can be used for different door configurations without having to extrude different thresholds for each configuration.

### BRIEF SUMMARY

The following paragraphs present a summary of various embodiments of the present disclosure and are merely examples of potential embodiments. As such, the summary is not meant to limit the subject matter or variations of various embodiments discussed herein.

In some aspects, the techniques described herein relate to a universal threshold, including: a base threshold portion, wherein the base threshold portion includes a base attachment receiving mechanism at a first end and a slope portion at a second end, wherein the base threshold portion includes at least one weep hole defined along a longitudinal length of the base threshold portion; a bumper adapter coupled to the base threshold portion, wherein the bumper adapter is positioned to restrict movement of a door during usage; and at least one seal coupled to the base threshold portion for sealing the door during usage.

In some aspects, the techniques described herein relate to a universal entryway threshold, further including a slope back adapter, wherein the slope back adapter provides a sloped surface opposite the slope portion of the base threshold portion.

In some aspects, the techniques described herein relate to a universal entryway threshold, wherein the slope back adapter is coupled to the base threshold portion.

In some aspects, the techniques described herein relate to a universal entryway threshold, wherein the slope back adapter includes a slope attachment mechanism, wherein the slope back adapter is coupled to the base threshold portion via a coupling of the slope attachment mechanism to the base attachment receiving mechanism.

In some aspects, the techniques described herein relate to a universal entryway threshold, further including an extension adapter, wherein the extension adapter is positioned between the slope back adapter and the base threshold portion.

In some aspects, the techniques described herein relate to a universal entryway threshold, wherein the extension adapter includes an extension attachment receiving mechanism at a first end and an extension attachment mechanism at a second end, wherein the extension attachment receiving mechanism couples with a slope attachment mechanism of the slope back adapter and the extension attachment mechanism couples with the base attachment receiving mechanism of the base threshold portion.

In some aspects, the techniques described herein relate to a universal entryway threshold, wherein the at least one seal defines a bulb seal, wherein the bulb seal includes a bulb section and an attachment section.

In some aspects, the techniques described herein relate to a universal entryway threshold, wherein the base threshold portion defines at least one receiving recess to receive the at least one seal.

In some aspects, the techniques described herein relate to a universal entryway threshold, wherein the at least one receiving recess includes a second seal receiving recess adjacent to the slope portion, wherein the second seal receiving recess is positioned orthogonal to an area in which the door swings during usage, wherein the at least one seal received by the second seal receiving recess abuts the door in an instance in which the door is closed.

In some aspects, the techniques described herein relate to a universal entryway threshold, wherein the universal threshold is ADA compliant.

In some aspects, the techniques described herein relate to a universal entryway threshold, further including an inswing adapter, wherein the base threshold portion is coupled to the inswing adapter.

In some aspects, the techniques described herein relate to a universal entryway threshold, wherein the inswing adapter includes one or more weep holes.

In some aspects, the techniques described herein relate to a universal entryway threshold, wherein the inswing adapter is positioned below the base threshold portion upon an installation.

In some aspects, the techniques described herein relate to a universal entryway threshold, wherein the at least one weep hole in the base threshold portion are positioned below the bumper adapter upon coupling of the bumper adapter to the base threshold portion.

In some aspects, the techniques described herein relate to a universal entryway threshold, wherein at least one of the at least one weep hole in the base threshold portion are defined within a seal receiving recess.

In some aspects, the techniques described herein relate to a universal entryway threshold, wherein the seal receiving recess is a second seal receiving recess defined on the base threshold portion.

In some aspects, the techniques described herein relate to a universal entryway threshold, wherein the base threshold portion includes a first base attachment mechanism and a second base attachment mechanism to couple to the bumper adapter.

In some aspects, the techniques described herein relate to a universal entryway threshold, wherein at least one of the at least one weep hole in the base threshold portion are defined on the first base attachment mechanism.

In some aspects, the techniques described herein relate to a universal entryway threshold, wherein the first base attachment mechanism defines one or more teeth to engage with the bumper adapter.

In some aspects, the techniques described herein relate to a universal entryway threshold, wherein the bumper adapter includes a first bumper attachment mechanism and a second bumper attachment mechanism, wherein the first bumper attachment mechanism couples with the first base attachment mechanism and the second bumper attachment mechanism couples with the second base attachment mechanism.

In some aspects, the techniques described herein relate to a method of manufacturing a universal entryway threshold, the method including: providing a base threshold portion, wherein the base threshold portion includes a base attachment receiving mechanism at a first end and a slope portion at a second end; defining at least one weep hole along a longitudinal length of the base threshold portion; coupling a bumper adapter to the base threshold portion, wherein the bumper adapter is positioned to restrict movement of a door during usage; and coupling at least one seal to the base threshold portion for sealing the door during usage.

In some aspects, the techniques described herein relate to a method, further including providing a slope back adapter, wherein the slope back adapter provides a sloped surface opposite the slope portion of the base threshold portion.

In some aspects, the techniques described herein relate to a method, wherein the slope back adapter is coupled to the base threshold portion.

In some aspects, the techniques described herein relate to a method, wherein the slope back adapter includes a slope attachment mechanism, wherein the slope back adapter is coupled to the base threshold portion via a coupling of the slope attachment mechanism to the base attachment receiving mechanism.

In some aspects, the techniques described herein relate to a method, further including providing an extension adapter, wherein the extension adapter is positioned between the slope back adapter and the base threshold portion.

In some aspects, the techniques described herein relate to a method, wherein the extension adapter includes an extension attachment receiving mechanism at a first end and an extension attachment mechanism at a second end, wherein the extension attachment receiving mechanism couples with a slope attachment mechanism of the slope back adapter and the extension attachment mechanism couples with the base attachment receiving mechanism of the base threshold portion.

In some aspects, the techniques described herein relate to a method, wherein the at least one seal defines a bulb seal, wherein the bulb seal includes a bulb section and an attachment section.

In some aspects, the techniques described herein relate to a method, wherein the base threshold portion defines at least one receiving recess to receive the at least one seal.

In some aspects, the techniques described herein relate to a method, wherein the at least one receiving recess includes a second seal receiving recess adjacent to the slope portion, wherein the second seal receiving recess is positioned orthogonal to an area in which the door swings during usage, wherein the at least one seal received by the second seal receiving recess abuts the door in an instance in which the door is closed.

In some aspects, the techniques described herein relate to a method, wherein the universal threshold is ADA compliant.

In some aspects, the techniques described herein relate to a method, further including providing an inswing adapter, wherein the base threshold portion is coupled to the inswing adapter.

In some aspects, the techniques described herein relate to a method, further including defining one or more weep holes in the inswing adapter.

In some aspects, the techniques described herein relate to a method, wherein the inswing adapter is positioned below the base threshold portion upon an installation.

In some aspects, the techniques described herein relate to a method, wherein the at least one weep hole in the base threshold portion are positioned below the bumper adapter upon coupling of the bumper adapter to the base threshold portion.

In some aspects, the techniques described herein relate to a method, wherein at least one of the at least one weep hole in the base threshold portion are defined within a seal receiving recess.

In some aspects, the techniques described herein relate to a method, wherein the seal receiving recess is a second seal receiving recess defined on the base threshold portion.

In some aspects, the techniques described herein relate to a method, wherein the base threshold portion includes a first base attachment mechanism and a second base attachment mechanism to couple to the bumper adapter.

In some aspects, the techniques described herein relate to a method, wherein at least one of the at least one weep hole in the base threshold portion are defined on the first base attachment mechanism.

In some aspects, the techniques described herein relate to a method, wherein the first base attachment mechanism defines one or more teeth to engage with the bumper adapter.

In some aspects, the techniques described herein relate to a method, wherein the bumper adapter includes a first bumper attachment mechanism and a second bumper attachment mechanism, wherein the first bumper attachment mechanism couples with the first base attachment mechanism and the second bumper attachment mechanism couples with the second base attachment mechanism.

These and other advantages will be apparent to those skilled in the art of door design and installation particularly for buildings in areas where security or severe weather is a concern.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings

FIG. 1 illustrates various cross-sections of example embodiments of an extruded lineal for a door threshold, in accordance with various embodiments of the present disclosure;

FIGS. 2A-2D illustrate various components of the extruded lineal shown in FIG. 1, in accordance with various embodiments of the present disclosure;

FIG. 3A illustrates an installed threshold with a bulb seal installed on the threshold, in accordance with various embodiments of the present disclosure;

FIG. 3B illustrates the bulb seal being depressed in an instance in which a door is being closed, in accordance with various embodiments of the present disclosure;

FIG. 4 illustrates the installed threshold with an outswing adapter, in accordance with various embodiments of the present disclosure;

FIG. 5 illustrates the installed threshold with an inswing adapter installed, in accordance with various embodiments of the present disclosure; and

FIG. 6 illustrates an example threshold with various attachments, in accordance with various embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

The term “building” will be used here for convenience to mean any structure with openings in its walls. The structure includes by way of example, and not of limitation, homes, apartment buildings, and commercial buildings. The word “walls” refers to barriers such as walls, ceilings, and floors, that are positioned between the inside of the building and its outside.

The term “customizable” is used herein to describe the ability to choose from a selection of options among protective mechanisms that protect the interior of a building from physical damage as a result of severe weather or a security threat outside the building. The features selected from among the options are added to an extruded, pultruded, or co-extruded frame of a that was manufactured with specific elements. These protective mechanisms improve the ability of the door to withstand increased stress from a security threat, high winds, heavy rain, hurricanes, and flying debris or hail.

The term “door” will be used to indicate an entry and egress point in a building, and shall include framing along with the ability to cover the door with the disclosure herein.

The term “extruded” is used herein for convenience but components herein may be formed in any way customary in the industry, for example, pultruded, and co-extruded with other materials.

### I. Example Use Case

In some aspects, the techniques described herein relate to a universal threshold, including: a base threshold portion, wherein the base threshold portion includes a base attachment receiving mechanism at a first end and a slope portion at a second end, wherein the base threshold portion includes at least one weep hole defined along a longitudinal length of the base threshold portion; a bumper adapter coupled to the base threshold portion, wherein the bumper adapter is positioned to restrict movement of a door during usage; and at least one seal coupled to the base threshold portion for sealing the door during usage.

In some aspects, the techniques described herein relate to a universal threshold, further including a slope back adapter, wherein the slope back adapter provides a sloped surface opposite the slope portion of the base threshold portion.

In some aspects, the techniques described herein relate to a universal threshold, wherein the slope back adapter is coupled to the base threshold portion.

In some aspects, the techniques described herein relate to a universal threshold, wherein the slope back adapter includes a slope attachment mechanism, wherein the slope back adapter is coupled to the base threshold portion via a coupling of the slope attachment mechanism to the base attachment receiving mechanism.

In some aspects, the techniques described herein relate to a universal threshold, further including an extension adapter, wherein the extension adapter is positioned between the slope back adapter and the base threshold portion.

In some aspects, the techniques described herein relate to a universal threshold, wherein the extension adapter includes an extension attachment receiving mechanism at a first end and an extension attachment mechanism at a second end, wherein the extension attachment receiving mechanism couples with a slope attachment mechanism of the slope back adapter and the extension attachment mechanism couples with the base attachment receiving mechanism of the base threshold portion.

In some aspects, the techniques described herein relate to a universal threshold, wherein the at least one seal defines a bulb seal, wherein the bulb seal includes a bulb section and an attachment section.

In some aspects, the techniques described herein relate to a universal threshold, wherein the base threshold portion defines at least one receiving recess to receive the at least one seal.

In some aspects, the techniques described herein relate to a universal threshold, wherein the at least one receiving recess includes a second seal receiving recess adjacent to the slope portion, wherein the second seal receiving recess is positioned orthogonal to an area in which the door swings during usage, wherein the at least one seal received by the second seal receiving recess abuts the door in an instance in which the door is closed.

In some aspects, the techniques described herein relate to a universal threshold, wherein the universal threshold is ADA compliant.

In some aspects, the techniques described herein relate to a universal threshold, further including an inswing adapter, wherein the base threshold portion is coupled to the inswing adapter.

In some aspects, the techniques described herein relate to a universal threshold, wherein the inswing adapter includes one or more weep holes.

In some aspects, the techniques described herein relate to a universal threshold, wherein the inswing adapter is positioned below the base threshold portion upon an installation.

In some aspects, the techniques described herein relate to a universal threshold, wherein the at least one weep hole in the base threshold portion are positioned below the bumper adapter upon coupling of the bumper adapter to the base threshold portion.

In some aspects, the techniques described herein relate to a universal threshold, wherein at least one of the at least one weep hole in the base threshold portion are defined within a seal receiving recess.

In some aspects, the techniques described herein relate to a universal threshold, wherein the seal receiving recess is a second seal receiving recess defined on the base threshold portion.

In some aspects, the techniques described herein relate to a universal threshold, wherein the base threshold portion includes a first base attachment mechanism and a second base attachment mechanism to couple to the bumper adapter.

In some aspects, the techniques described herein relate to a universal threshold, wherein at least one of the at least one weep hole in the base threshold portion are defined on the first base attachment mechanism.

In some aspects, the techniques described herein relate to a universal threshold, wherein the first base attachment mechanism defines one or more teeth to engage with the bumper adapter.

In some aspects, the techniques described herein relate to a universal threshold, wherein the bumper adapter includes a first bumper attachment mechanism and a second bumper attachment mechanism, wherein the first bumper attachment mechanism couples with the first base attachment mechanism and the second bumper attachment mechanism couples with the second base attachment mechanism.

In some aspects, the techniques described herein relate to a method for manufacturing a universal threshold.

### II. Systems and Methods

Door threshold design may be based on the type of door, the swing orientation of the door, the requirements of the door threshold (e.g., ADA compliance), and/or the like. As such, door thresholds may include many different designs.

One aspect of the present disclosure is provide a universal threshold for one jamb preparation, thus saving inventory space, tooling expense, and labor. In additional the one jamb preparation simplifies replacement and allows for easy repair. Typical threshold installation and/or repair comprises removing the old threshold or preparing the surface, which typically resides against the jambs. The jambs comprise a jamb face, jamb rabbet, and a casing is also formed. The threshold or sill is above the flooring and designed to fit flush against the jamb, and sitting above the flooring and sill. Thus, traditional wood thresholds were difficult to install without removing or preparing both jambs, the present disclosure enables a one jamb removal installation, and greatly reduces costs and the lifetime of thresholds.

Water or other moisture build-up is an on-going issue with any entryway system. Entryways, such as doors, are often made out of wood and/or are adjacent to wood floor structures and/or wall frames. As such, a build-up of moisture from outdoor elements can create potential issues, such as rot, mold, and/or the like, that can cause serious issues to the door system and/or surrounding areas. Door thresholds are also susceptible to moisture build-up due to contact with damp or wet shoes. Traditional door thresholds provide little to no moisture management that provide protection from any built-up moisture. Various embodiments of the present disclosure provide for one or more weep holes within the threshold structure, that provides an outlet for water or other moisture to escape the threshold.

In various embodiments, a universal threshold is provided that includes multiple interchangeable components that allow for the threshold to be modified based on the type of door system. The universal threshold may be modified to allow for an outswing door or an inswing door. The universal threshold may be equipped with various different seals (e.g., a bulb seal) to provide additional protection. Additionally, the universal threshold may include one or more weep holes that allow moisture control to manage the moisture in the universal threshold.

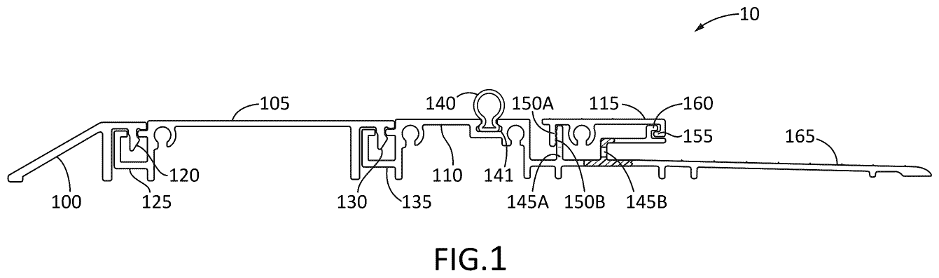

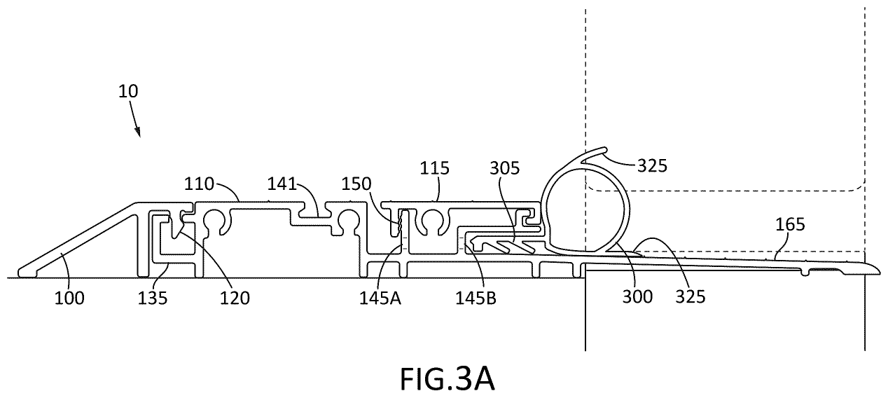

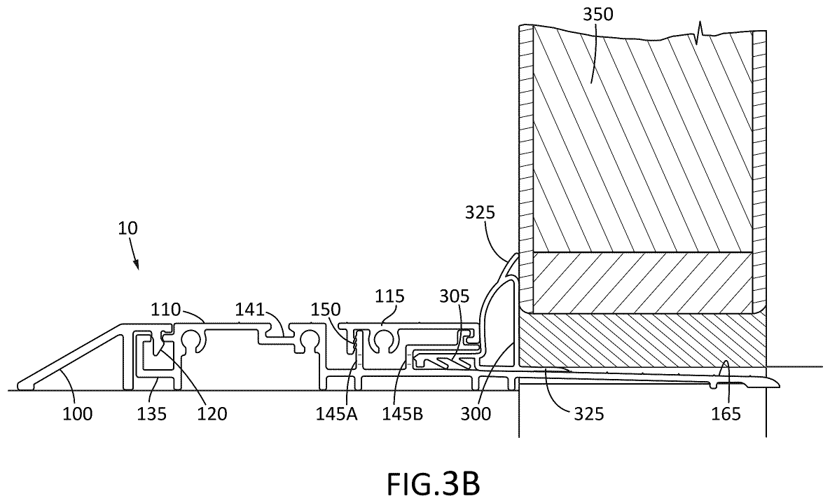

Various embodiments of the universal threshold can be configured to provide compliance with various safety requirements (e.g., Americans with Disabilities Act (ADA) compliance). For example, the universal threshold of FIGS. 1, 3A and 3B allow for ADA compliance. The interchangeable components allow for the universal threshold to be changed based on the use case (e.g., ADA compliant v. no compliance requirements). As such, the universal threshold of various embodiments may be adjusted for many different applications without having to redesign the components, allowing for an extruded component to be used for many different thresholds, thereby reducing design time and cost.

### III. With Reference to the Figures

Referring now to the figures, example embodiments of a universal threshold 10 (or sill) are provided. The universal threshold 10 may be used in a door assembly, as detailed in various embodiments herein. The universal threshold 10 may include one or more individual components discussed herein that may be interchanged for various different threshold applications. For example, the components of the universal threshold 10 may be removed, replaced, and/or otherwise interchanged to accommodate for different door designs (e.g., outswing doors, inswing doors, etc.).

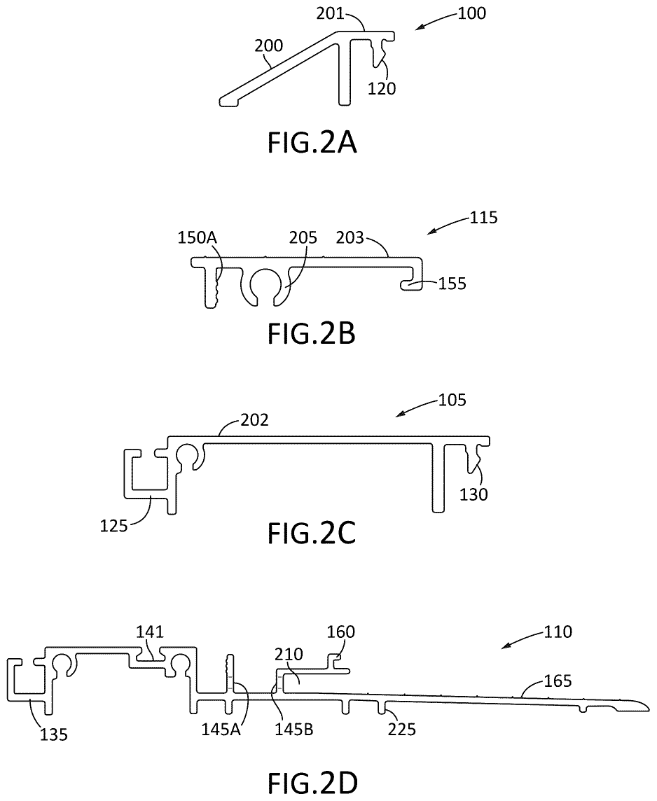

FIG. 1 illustrates various cross-sections of example embodiments of an extruded lineal for a door threshold (e.g., a universal threshold 10). The universal threshold 10 may include one or more components attached or otherwise coupled to one another, as shown in FIGS. 1-6. The universal threshold 10 may include a slope back adapter 100 (shown in more detail in FIG. 2A), an extension adapter 105 (shown in more detail in FIG. 2C), a base threshold portion 110 (shown in more detail in FIG. 2D), and/or a bumper adapter 115 (shown in more detail in FIG. 2B). Each of the components shown in FIG. 1 are shown individually in FIGS. 2A-2D.

The universal threshold components of various embodiments, such as the universal threshold 10 of FIG. 1 may be long, rigid, co-extruded article of manufacture that are to be cut into sections. The sections have a specified length and can be assembled together to form the universal threshold. The lineal profiles shown in FIG. 1 contain representative internal features common to many door thresholds of various embodiments. The universal threshold 10 may be used in combination with other door system components, such as a door frame. Therefore, the components of the universal threshold 10 are able to be used with existing door system components, while allowing customizability.

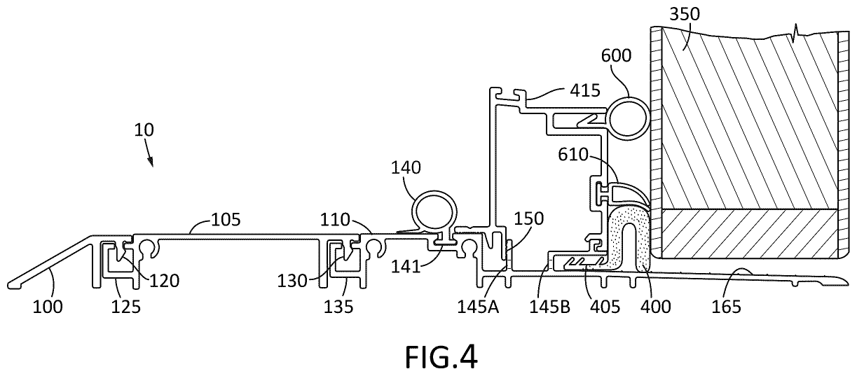

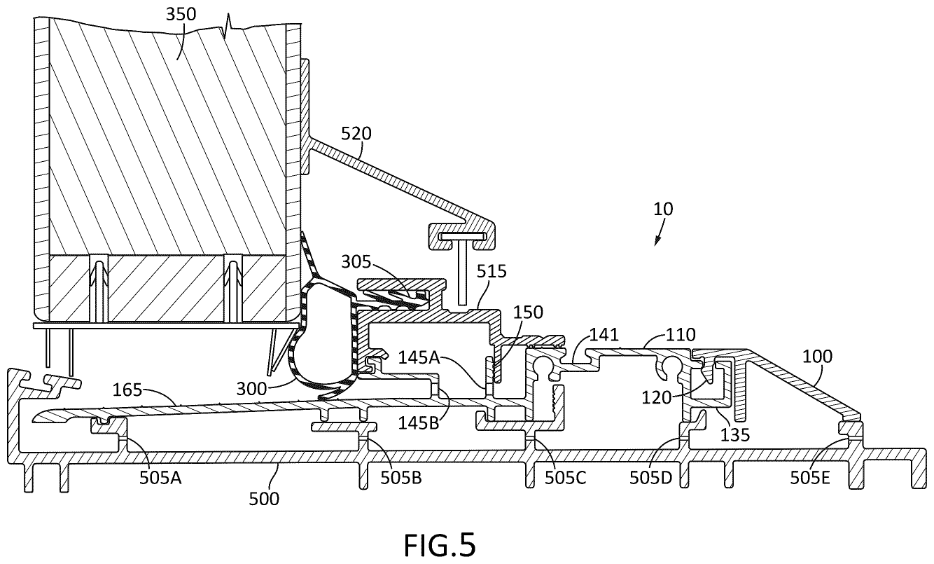

The example universal threshold 10 includes the slope back adapter 100 coupled to the extension adapter 105, the extension adapter 105 being coupled to the base threshold portion 110, and the bumper adapter 115 being coupled to the base threshold portion 110. FIG. 1 is merely one example configuration. For example, the universal threshold 10 of FIGS. 3A and 3B do not use an extension adapter 105 and instead the slope back adapter is coupled to the base threshold portion 110, the universal threshold 10 of FIGS. 4 and 5 use different bumper adapter designs (e.g., bumper adapter 415 in FIG. 4 and bumper adapter 515 in FIG. 5) instead of the bumper adapter 115 of FIG. 1. As such, the components discussed herein may be interchanged and/or removed based on the desired threshold design.

An example slope back adapter 100 is shown in FIG. 2A. The slope back adapter 100 may include a sloped surface 200 that allows the universal threshold 10 to be traversed (e.g., the sloped surface 200 may allow the universal threshold 10 to be ADA compliant). The slope back adapter 100 may include a slope attachment mechanism 120 to couple the slope back adapter 100 to another component of the universal threshold 10. For example, the slope attachment mechanism 120 is shown coupled to the extension adapter 105 in FIG. 1 and the base threshold portion 110 in FIGS. 3A and 3B. The slope attachment mechanism 120 may be a protrusion (e.g., a cantilever lever), such as a tapered hook, that can be received by a slot, such as the base attachment receiving mechanism 135 and/or the extension attachment receiving mechanism 125.

The slope attachment mechanism 120 may be structured such that the sloped surface 200, upon leveling off (e.g., flat surface 201) fits flush with the adjacent component (e.g., as shown in FIG. 1, the connection between the slope back adapter 100 and the extension adapter 105 provide for a relatively flat surface). As such, the slope attachment mechanism 120 may be structured to allow a flat surface to be maintained between adjacent components. The sloped surface of the slope back adapter 100 provides a sloped surface opposite the slope portion 165 of the base threshold portion 110, as shown in FIG. 1.

An example bumper adapter 115 is shown in FIG. 2B. The bumper adapter 115 may be coupled to the base threshold portion 110. Examples of the coupling of the bumper adapter 115 to the base threshold portion 110 are shown in FIGS. 1, 3A, and 3B. The bumper adapter 115 may be positioned to restrict movement of a door during usage (e.g., shown in FIG. 3B).

The bumper adapter 115 may be coupled to the base threshold portion 110 using a first bumper attachment mechanism 150A and/or a second bumper attachment mechanism 155. The first bumper attachment mechanism 150A may be one or more teeth or protrusions that are structured to engage corresponding teeth or protrusions on the base threshold portion 110 (e.g., at a first base attachment mechanism 150B). The attachment of the first bumper attachment mechanism 150A and the first base attachment mechanism 150B are also labeled as engagement 150 in various embodiments. The second bumper attachment mechanism 155 may form a hook to engage a second base attachment mechanism 160. In various embodiments, the bumper adapter 115 may have a flat surface 203 that is generally aligned with the flat surface 201 of the slope back adapter 100 and/or the flat surface 202 of the extension adapter 105 (e.g., in an instance in which an extension adapter 105 is used). In various embodiments, a recess 205 may also be provided in the bumper adapter 115 to provide for additional functionality of the bumper adapter (e.g., to allow coupling to different components and/or receive a seal).

An example extension adapter 105 is shown in FIG. 2C. In an embodiment in which an extension adapter 105 is used, the extension adapter 105 may be coupled to the slope back adapter 100 at a first end of the extension adapter (e.g., via the extension attachment receiving mechanism 125) and coupled to the base threshold portion 110 at a second end of the extension adapter (e.g., via the extension attachment mechanism 130). The extension attachment receiving mechanism 125 may define a slot defined to receive an insert, such as a tapered hook. Example inserts received by the extension attachment receiving mechanism 125 may include the slope attachment mechanism 120 (e.g., shown in FIG. 1). As discussed herein, the structure of the base attachment receiving mechanism 135 and the extension attachment receiving mechanism 125 of the extension adapter 105 may be the same or similar, such that in different configurations, each could receive the same insert, such as the slope attachment mechanism 120. The coupling of the slope attachment mechanism 120 and extension attachment receiving mechanism 125 may provide for the flat surface 201 of the slope back adapter 100 and the flat surface 202 of the extension adapter 105 to be aligned, as shown in FIG. 1.

The extension adapter 105 may include an extension attachment mechanism 130 to couple the extension adapter 105 to another component of the universal threshold 10. For example, the extension attachment mechanism 130 is shown coupled to the base threshold portion 110 in FIG. 1. The extension attachment mechanism 130 may be a protrusion (e.g., a cantilever lever), such as a tapered hook, that can be received by a slot, such as the base attachment receiving mechanism 135. In various embodiments, the extension attachment mechanism 130 may be the same or similar to the shape of the slope attachment mechanism 120, such that either the extension attachment mechanism 130 or the slope attachment mechanism 120 may engage or otherwise couple to the base attachment receiving mechanism 135 of the base threshold portion 110.

An example base threshold portion 110 is shown in FIG. 2D. The base threshold portion 110 may be provided in the direction of the door swing. For example, as shown in FIGS. 3B and 4, the base threshold portion 110 may be positioned in the direction of the outswing of the door and, as shown in FIG. 5, the base threshold portion 110 may be positioned in the direction of the inswing of the door. For example, whether the door is in an outswing or inswing configuration, the door 350 may be positioned above the base threshold portion 110 when closed. The base threshold portion 110 may include the base attachment receiving mechanism 135. The base attachment receiving mechanism 135 may be defined at a first end of the base threshold portion 110 opposite the slope portion 165. The base attachment receiving mechanism 135 may define a slot defined to receive an insert, such as a tapered hook. Example inserts received by the base attachment receiving mechanism 135 may include the extension attachment mechanism 130 (e.g., shown in FIG. 1) and/or slope attachment mechanism 120 (e.g., shown in FIGS. 3A and 3B). As discussed herein, the structure of base attachment receiving mechanism 135 and the extension attachment receiving mechanism 125 of the extension adapter 105 may be the same or similar, such that in different configurations, each could receive the same insert, such as the slope attachment mechanism 120.

The base threshold portion 110 may also include one or more seal receiving recess. For example, the base threshold portion 110 may include a first seal receiving recess 141 and/or a second seal receiving recess 210. The seal receiving recesses may be provided to receive seals for the door system. For example, the first seal receiving recess 141 is shown in FIG. 1 with a seal 140 and the second seal receiving recess 210 is shown in multiple figures with different seals (e.g., bulb seal 300 in FIGS. 3A and 3B, a U-shaped seal 400 in FIG. 4).

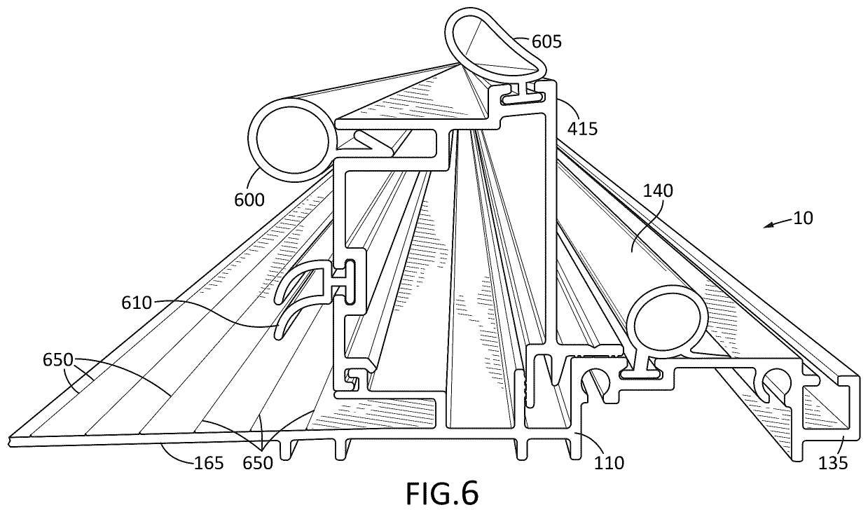

Additional seal receiving holes may also be provided in the base threshold portion 110 and/or a bumper adapter. An example of a bumper adapter having seal receiving recesses is the bumper adapter 415 shown in FIGS. 4 and 6 defines multiple seal receiving recesses (e.g., to receive seals 600, 605, and 610 shown in FIG. 6). The amount of seals used may be based on the door system configuration (e.g., a door system may have a main door and a screen door, for which one or more seals are implemented for each of the main door and the screen door). In various embodiments, the type of door application (e.g., interior door, exterior door, usage amount, etc.) may affect the number of seals used. As shown in FIG. 6, the seals may run along the longitudinal length of the universal threshold 10. In various embodiments, one or more seals may be provided for less than the entire length of the universal threshold.

In various embodiments, a second base attachment mechanism 160 may be provided. The second base attachment mechanism 160 may be a hook that couples to the second bumper attachment mechanism 155. The second base attachment mechanism 160 may be provided above the second seal receiving recess 210.

The base threshold portion 110 may also include a slope portion 165. The slope portion 165 may form a ramp when positioned within a door frame (e.g., to allow for ADA compliance and/or easier traversal). The slope portion 165 may also include one or more protrusions 650 shown in FIG. 6 that allow for easier traversal. The slope portion 165 and other portions of the base threshold portion 110 may include leg protrusions (e.g., leg protrusion 225) that engage with a surface upon installation (e.g., to maintain the desired orientation of the universal threshold). The length of the leg protrusions may cause the sloped nature of the slope portion 165.

As shown in FIG. 1, one or more weep holes 145A, 145B may be provided along the universal threshold 10. For example, the weep hole(s) 145A, 145B may be provided in the base threshold portion 110. In various embodiments, the weep hole(s) 145A may be one or more weep holes along the longitudinal length of the universal threshold 10. For example, one or more weep holes may be provided along the base threshold portion 110 (e.g., the weep hole(s) 145A may representative of a single hole or multiple holes along the longitudinal direction.). In various embodiments, the weep holes 145A may be separated to allow any liquid (e.g., water) to find weep hole(s) 145A to pass through. Additionally, the weep hole(s) 145B may be one or more weep holes along the longitudinal length of the universal threshold 10. For example, one or more weep holes may be provided along the base threshold portion 110 (e.g., going into the page as shown). In various embodiments, the weep holes 145B may be separated to allow any liquid (e.g., water) to find weep hole(s) 145B to pass through. A weep hole of the weep hole(s) 145A and a weep hole of the weep hole(s) 145B may be aligned to allow the liquid to pass through. Various other weep hole(s) may also be provided at other locations on the universal threshold 10 (e.g., at other positions on the base threshold portion 110).

Referring now to FIGS. 3A and 3B, an example universal threshold 10 is shown with a bulb seal 300 attached to the universal threshold is provided. FIG. 3A illustrates the universal threshold of various embodiments without a door closed against the bulb seal 300 and FIG. 3B illustrates the universal threshold 10 of FIG. 3A with a door closed against the bulb seal 300. As shown, the universal threshold 10 includes the slope back adapter 100, the bumper adapter 115, and the base threshold portion 110. As shown in FIGS. 1 and 3A-3B, the slope back adapter 100 may be capable of coupling to either the extension adapter 105 (shown in FIG. 1) or the bumper adapter 115 (shown in FIGS. 3A and 3B). The universal threshold 10 of FIGS. 3A and 3B are set up for an outswing door. Additionally, the universal threshold 10 of FIGS. 3A and 3B may be ADA compliant.

In various embodiments, the bulb seal 300 may be received by the second seal receiving recess 210 adjacent to the slope portion 165 of the base threshold portion 110. The second seal receiving recess 210 is positioned orthogonal to an area in which the door swings during usage, such that the bulb seal 300 abuts the door in an instance in which the door is closed.

The bulb seal 300 may be a generally circular shape with a hollow center. The compression of the bulb seal is allowed due to the hollow center, as shown in FIG. 3B, in which the bulb seal 300 is depressed and deformed. The bulb seal 300 may be made out of a resilient material (e.g., rubber, composite, etc.) that allows for the bulb seal 300 to be depressed (as shown in FIG. 3B) and then return to the generally circular shape shown in FIG. 3A.

One or more fingers 325 that extend from the bulb seal to engage either the door 350 or the universal threshold 10. As such, the fingers 325 may provide additional sealing functionality. The bulb seal may include an attachment protrusion 305, which is received by a seal receiving recess, such as the second seal receiving recess 210. In various embodiments, the seal receiving recess may include coupling means, such as grooves or teeth to engage with a seal (e.g., the attachment protrusion 305 include multiple flexible teeth to engage with the seal receiving recess).

Referring now to FIG. 4, another example embodiment of the universal threshold 10 is provided. The universal threshold 10 includes the slope back adapter 100, the extension adapter 105, and the base threshold portion 110 shown in FIG. 1. However, the bumper adapter 115 is replaced with a different bumper adapter 415, which does not align with the flat surfaces of the slope back adapter 100 and/or the extension adapter 105. The bumper adapter 415 may be used in applications in which ADA compliance is not required. For example, the sealing of the door may be a higher factor (e.g., an outside facing door that often withstands wind) and/or other doors may have ADA compliance on a building. As such, the universal threshold 10 may be converted to use the bumper adapter 415. The bumper adapter 415 may be positioned to restrict movement of a door during usage, just as the bumper adapter 115 and the bumper adapter 515. The bumper adapter 415 may also have the same attachment mechanisms to allow for attachment to the base threshold portion 110.

FIG. 4 also illustrates a U-shaped seal 400. The U-shaped seal 400 can be depressed upon the closing of the door (e.g., the U is pushed together, as shown in FIG. 4). Similar to the bulb seal 300 of FIGS. 3A and 3B, the U-shaped seal 400 may be resilient, such that the U-shaped seal 400 may be depressed upon closing the door and then return to the previous U-shape upon opening of the door. The U-shaped seal 400 may be made out of the same or similar materials as the bulb seal 300. Additional seals 600, 140, and 610 are adapted based on the configuration of the threshold and the door, jamb, and sill.

Referring now to FIG. 5, another example embodiment of the universal threshold 10 is provided. The universal threshold 10 of FIG. 5 is designed for use with an inswing door. To do this, an inswing adapter 500 is provided that supports the other components of the universal threshold 10. For example, the universal threshold 10 of FIG. 5 includes the slope back adapter 100, the base threshold portion 110 and a different bumper adapter 515 assembled in the same fashion as discussed in various embodiments. The inswing adapter 500 includes one or more leg receiving platforms, which are structured to receive the leg protrusions of the various components (e.g., the slope back adapter 100 and the base threshold portion 110). One or more weep holes may also be defined within the inswing adapter. For example, the weep holes 505A, 505B, 505C, 505D, 505E are provided adjacent to the leg receiving platforms. Any number of weep holes may be provided along the longitudinal length of the inswing adapter 500. For example, the weep hole 505A may be representative of a single hole or multiple holes along the longitudinal direction.

The different bumper adapter 515 allows for an inswing door application. As shown, the bumper adapter 515 may have the same attachment locations as the bumper adapter 115 and/or the bumper adapter 415, allowing different bumper adapters to be interchanged for different applications. Additionally, the bumper adapter 515 may be positioned to restrict movement of a door during usage, just as the bumper adapter 115 and the bumper adapter 415.

The bumper adapter 515 shown in FIG. 5 includes a seal receiving recess that receives the attachment protrusion 305 of the bulb seal 300. While the bulb seal 300 is attached to the bumper adapter 515, the bulb seal 300 still maintains the same functionality discussed in reference to FIGS. 3A and 3B. The bumper adapter 515 may be structured with a recess to allow for a door to have a drip lip 520 installed. In such an instance, the drip lip 520 may engage with the bumper adapter 515 to provide for additional sealing of the door.

Referring now to FIG. 6, an example base threshold portion 110 and bumper adapter 415 are shown. The bumper adapter 415 is the same bumper adapter 415 shown in FIG. 4. FIG. 6 generally illustrates the longitudinal direction of a component (e.g., each of the slope back adapter 100, the extension adapter 105, the base threshold portion 110, and the bumper adapter of various embodiments may be extruded as the base threshold portion 110 and the bumper adapter 415 are shown in FIG. 6).

FIG. 6 also illustrates seals (e.g., seals 140, 600, 605, 610) being positioned within a seal receiving recess. For example, seals 140, 605, and 610 may slide into an end of the given seal receiving recess, which acts as rail system to maintain the seal in place (e.g., the seal has protrusions to maintain position within the seal receiving recess). Additionally, the seal 600 has a tooth engagement, similar to the bulb seal 300 discussed herein. In the embodiment of FIG. 6, seals 600, 610 are used in a similar fashion to the bulb seal 300 of FIGS. 3A and 3B (e.g., engaging the door 350). Various types of seals may be used for the same or similar functionality. The positioning and type of seal may be based on the type of door and application. For example, exterior doors may have more seals than an interior door.

Unless stated otherwise, any of the configurations of various embodiments may be used interchangeably. It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### IV. Claims Clauses

Clause 1. A universal threshold, comprising: a base threshold portion, wherein the base threshold portion comprises a base attachment receiving mechanism at a first end and a slope portion at a second end, wherein the base threshold portion comprises at least one weep hole defined along a longitudinal length of the base threshold portion; a bumper adapter coupled to the base threshold portion, wherein the bumper adapter is positioned to restrict movement of a door during usage; and at least one seal coupled to the base threshold portion for sealing the door during usage.

Clause 2. The universal threshold of Clause 1, further comprising a slope back adapter, wherein the slope back adapter provides a sloped surface opposite the slope portion of the base threshold portion.

Clause 3. The universal threshold of Clause 2, wherein the slope back adapter is coupled to the base threshold portion.

Clause 4. The universal threshold of Clause 3, wherein the slope back adapter comprises a slope attachment mechanism, wherein the slope back adapter is coupled to the base threshold portion via a coupling of the slope attachment mechanism to the base attachment receiving mechanism.

Clause 5. The universal threshold of Clause 2, further comprising an extension adapter, wherein the extension adapter is positioned between the slope back adapter and the base threshold portion.

Clause 6. The universal threshold of Clause 5, wherein the extension adapter comprises an extension attachment receiving mechanism at a first end and an extension attachment mechanism at a second end, wherein the extension attachment receiving mechanism couples with a slope attachment mechanism of the slope back adapter and the extension attachment mechanism couples with the base attachment receiving mechanism of the base threshold portion.

Clause 7. The universal threshold of Clause 1, wherein the at least one seal defines a bulb seal, wherein the bulb seal comprises a bulb section and an attachment section.

Clause 8. The universal threshold of Clause 1, wherein the base threshold portion defines at least one receiving recess to receive the at least one seal.

Clause 9. The universal threshold of Clause 8, wherein the at least one receiving recess comprises a second seal receiving recess adjacent to the slope portion, wherein the second seal receiving recess is positioned orthogonal to an area in which the door swings during usage, wherein the at least one seal received by the second seal receiving recess abuts the door in an instance in which the door is closed.

Clause 10. The universal threshold of Clause 2, wherein the universal threshold is ADA compliant.

Clause 11. The universal threshold of Clause 1, further comprising an inswing adapter, wherein the base threshold portion is coupled to the inswing adapter.

Clause 12. The universal threshold of Clause 11, wherein the inswing adapter comprises one or more weep holes.

Clause 13. The universal threshold of Clause 11, wherein the inswing adapter is positioned below the base threshold portion upon an installation.

Clause 14. The universal threshold of Clause 1, wherein the at least one weep hole in the base threshold portion are positioned below the bumper adapter upon coupling of the bumper adapter to the base threshold portion.

Clause 15. The universal threshold of Clause 1, wherein at least one of the at least one weep hole in the base threshold portion are defined within a seal receiving recess.

Clause 16. The universal threshold of Clause 15, wherein the seal receiving recess is a second seal receiving recess defined on the base threshold portion.

Clause 17. The universal threshold of Clause 1, wherein the base threshold portion comprises a first base attachment mechanism and a second base attachment mechanism to couple to the bumper adapter.

Clause 18. The universal threshold of Clause 17, wherein at least one of the at least one weep hole in the base threshold portion are defined on the first base attachment mechanism.

Clause 19. The universal threshold of Clause 17, wherein the first base attachment mechanism defines one or more teeth to engage with the bumper adapter.

Clause 20. The universal threshold of Clause 17, wherein the bumper adapter comprises a first bumper attachment mechanism and a second bumper attachment mechanism, wherein the first bumper attachment mechanism couples with the first base attachment mechanism and the second bumper attachment mechanism couples with the second base attachment mechanism.

Clause 21. A method of manufacturing a universal threshold, the method comprising: providing a base threshold portion, wherein the base threshold portion comprises a base attachment receiving mechanism at a first end and a slope portion at a second end; defining at least one weep hole along a longitudinal length of the base threshold portion; coupling a bumper adapter to the base threshold portion, wherein the bumper adapter is positioned to restrict movement of a door during usage; and coupling at least one seal to the base threshold portion for sealing the door during usage.

Clause 22. The method of Clause 21, further comprising providing a slope back adapter, wherein the slope back adapter provides a sloped surface opposite the slope portion of the base threshold portion.

Clause 23. The method of Clause 22, wherein the slope back adapter is coupled to the base threshold portion.

Clause 24. The method of Clause 23, wherein the slope back adapter comprises a slope attachment mechanism, wherein the slope back adapter is coupled to the base threshold portion via a coupling of the slope attachment mechanism to the base attachment receiving mechanism.

Clause 25. The method of Clause 22, further comprising providing an extension adapter, wherein the extension adapter is positioned between the slope back adapter and the base threshold portion.

Clause 26. The method of Clause 25, wherein the extension adapter comprises an extension attachment receiving mechanism at a first end and an extension attachment mechanism at a second end, wherein the extension attachment receiving mechanism couples with a slope attachment mechanism of the slope back adapter and the extension attachment mechanism couples with the base attachment receiving mechanism of the base threshold portion.

Clause 27. The method of Clause 21, wherein the at least one seal defines a bulb seal, wherein the bulb seal comprises a bulb section and an attachment section.

Clause 28. The method of Clause 21, wherein the base threshold portion defines at least one receiving recess to receive the at least one seal.

Clause 29. The method of Clause 28, wherein the at least one receiving recess comprises a second seal receiving recess adjacent to the slope portion, wherein the second seal receiving recess is positioned orthogonal to an area in which the door swings during usage, wherein the at least one seal received by the second seal receiving recess abuts the door in an instance in which the door is closed.

Clause 30. The method of Clause 22, wherein the universal threshold is ADA compliant.

Clause 31. The method of Clause 21, further comprising providing an inswing adapter, wherein the base threshold portion is coupled to the inswing adapter.

Clause 32. The method of Clause 31, further comprising defining one or more weep holes in the inswing adapter.

Clause 33. The method of Clause 31, wherein the inswing adapter is positioned below the base threshold portion upon an installation.

Clause 34. The method of Clause 21, wherein the at least one weep hole in the base threshold portion are positioned below the bumper adapter upon coupling of the bumper adapter to the base threshold portion.

Clause 35. The method of Clause 21, wherein at least one of the at least one weep hole in the base threshold portion are defined within a seal receiving recess.

Clause 36. The method of Clause 35, wherein the seal receiving recess is a second seal receiving recess defined on the base threshold portion.

Clause 37. The method of Clause 21, wherein the base threshold portion comprises a first base attachment mechanism and a second base attachment mechanism to couple to the bumper adapter.

Clause 38. The method of Clause 37, wherein at least one of the at least one weep hole in the base threshold portion are defined on the first base attachment mechanism.

Clause 39. The method of Clause 37, wherein the first base attachment mechanism defines one or more teeth to engage with the bumper adapter.

Clause 40. The method of Clause 37, wherein the bumper adapter comprises a first bumper attachment mechanism and a second bumper attachment mechanism, wherein the first bumper attachment mechanism couples with the first base attachment mechanism and the second bumper attachment mechanism couples with the second base attachment mechanism.

1. A universal entryway threshold, comprising:
a base threshold portion, wherein the base threshold portion comprises a base attachment receiving mechanism at a first end and a slope portion at a second end, wherein the base threshold portion comprises at least one weep hole defined along a longitudinal length of the base threshold portion;
a bumper adapter coupled to the base threshold portion, wherein the bumper adapter is positioned to restrict movement of a door during usage; and
at least one seal coupled to the base threshold portion for sealing the door during usage, wherein at least one of the at least one weep hole in the base threshold portion is defined within a seal receiving recess in which one of the at least one seal is positioned.

2. The universal entryway threshold of claim 1, further comprising a slope back adapter, wherein the slope back adapter provides a sloped surface opposite the slope portion of the base threshold portion.

3. The universal entryway threshold of claim 2, wherein the slope back adapter is coupled to the base threshold portion.

4. The universal entryway threshold of claim 2, further comprising an extension adapter, wherein the extension adapter is positioned between the slope back adapter and the base threshold portion.

5. The universal entryway threshold of claim 4, wherein the extension adapter comprises an extension attachment receiving mechanism at a first end and an extension attachment mechanism at a second end, wherein the extension attachment receiving mechanism couples with a slope attachment mechanism of the slope back adapter and the extension attachment mechanism couples with the base attachment receiving mechanism of the base threshold portion.

6. The universal entryway threshold of claim 1, wherein the at least one seal defines a bulb seal, wherein the bulb seal comprises a bulb section and an attachment section.

7. The universal entryway threshold of claim 1, further comprising an inswing adapter, wherein the base threshold portion is coupled to the inswing adapter.

8. The universal entryway threshold of claim 7, wherein the inswing adapter comprises one or more weep holes.

9. The universal entryway threshold of claim 1, wherein the at least one weep hole in the base threshold portion are positioned below the bumper adapter upon coupling of the bumper adapter to the base threshold portion.

10. (canceled)

11. A method of manufacturing a universal entryway threshold, the method comprising:
providing a base threshold portion, wherein the base threshold portion comprises a base attachment receiving mechanism at a first end and a slope portion at a second end;
defining at least one weep hole along a longitudinal length of the base threshold portion;
coupling a bumper adapter to the base threshold portion, wherein the bumper adapter is positioned to restrict movement of a door during usage; and
coupling at least one seal to the base threshold portion for sealing the door during usage, wherein at least one of the at least one weep hole in the base threshold portion is defined within a seal receiving recess in which one of the at least one seal is positioned.

12. The method of claim 11, further comprising providing a slope back adapter, wherein the slope back adapter provides a sloped surface opposite the slope portion of the base threshold portion.

13. The method of claim 12, wherein the slope back adapter is coupled to the base threshold portion.

14. The method of claim 12, further comprising providing an extension adapter, wherein the extension adapter is positioned between the slope back adapter and the base threshold portion.

15. The method of claim 14, wherein the extension adapter comprises an extension attachment receiving mechanism at a first end and an extension attachment mechanism at a second end, wherein the extension attachment receiving mechanism couples with a slope attachment mechanism of the slope back adapter and the extension attachment mechanism couples with the base attachment receiving mechanism of the base threshold portion.

16. The method of claim 11, wherein the at least one seal defines a bulb seal, wherein the bulb seal comprises a bulb section and an attachment section.

17. The method of claim 11, further comprising providing an inswing adapter, wherein the base threshold portion is coupled to the inswing adapter.

18. The method of claim 17, further comprising defining one or more weep holes in the inswing adapter.

19. The method of claim 11, wherein the at least one weep hole in the base threshold portion are positioned below the bumper adapter upon coupling of the bumper adapter to the base threshold portion.

20. (canceled)

21. The universal entryway threshold of claim 1, wherein the bumper adapter comprises a plurality of seal receiving recesses, wherein the plurality of seal receiving recesses comprises the seal receiving recess and at least one additional seal receiving recess defined above the seal receiving recess, wherein each of the at least one additional seal receiving recess is structured to receive one of the at least one seal, wherein each of the at least one seal is structured to contact a door upon closing of the door.

22. The method of claim 11, wherein the bumper adapter comprises a plurality of seal receiving recesses, wherein the plurality of seal receiving recesses comprises the seal receiving recess and at least one additional seal receiving recess defined above the seal receiving recess, wherein each of the at least one additional seal receiving recess is structured to receive one of the at least one seal, wherein each of the at least one seal is structured to contact a door upon closing of the door.
